(19) United States
(12) Patent Application Publication
(10) Pub. No.: US 2023/0173974 A1
(43) Pub. Date: Jun. 8, 2023

(54) HYBRID RATCHET

(71) Applicant: COMMERCIAL SEWING, INC., Torrington, CT (US)

(72) Inventor: David Mazzarelli, Torrington, CT (US)

(21) Appl. No.: 18/076,930

(22) Filed: Dec. 7, 2022

Related U.S. Application Data
(60) Provisional application No. 63/287,353, filed on Dec. 8, 2021.

(51) Int. Cl. B60P 7/08

(52) U.S. Cl. CPC B60P 7/083

(57) ABSTRACT

A ratchet mechanism includes a barrel defining an axis of rotation and a body and a handle coupled via the barrel. At least one force receiving member is operably coupled to at least one of the barrel, the body, and the handle. The at least one force receiving member is formed from a first material and at least one of the barrel, the body, and the handle is formed from a second material, different than the first material.

### CROSS-REFERENCE TO RELATED APPLICATIONS

This application claims the benefit of U.S. Provisional Application No. 63/287,353 filed Dec. 8, 2021, the disclosure of which is incorporated herein by reference in its entirety.

### BACKGROUND

Embodiments disclosed herein pertain to a ratchet strap tightening mechanism, and more particularly, to a ratchet strap tightening mechanism for use with a vehicle cover.

Various techniques are known for securing objects on a transport vehicle or a tarp or cover on an object such as a boat, for example, during transport of the object. One of the most common methods for securing an object includes tying ropes to attachment points on the transport vehicle and attaching the ropes to the object or tightening the ropes against the object. Bungee cords or the like may be attached to the ropes and to attachment points on the transport vehicle to additionally secure the object on the vehicle. In some applications, tie-down straps fitted with ratchet mechanisms adapted to tighten the straps may be used to secure the object to the vehicle.

### BRIEF DESCRIPTION

According to an embodiment, a ratchet mechanism includes a barrel defining an axis of rotation and a body and a handle coupled via the barrel. The handle is rotatable relative to the body about the axis of rotation. At least one force receiving member is operably coupled to at least one of the barrel, the body, and the handle. The at least one force receiving member is formed from a first material and at least one of the barrel, the body, and the handle is formed from a second material, different than the first material.

### BRIEF DESCRIPTION OF THE DRAWINGS

The following descriptions should not be considered limiting in any way. With reference to the accompanying drawings, like elements are numbered alike:

FIG. 1 is a perspective view of ratchet mechanism in a generally closed configuration according to an embodiment;

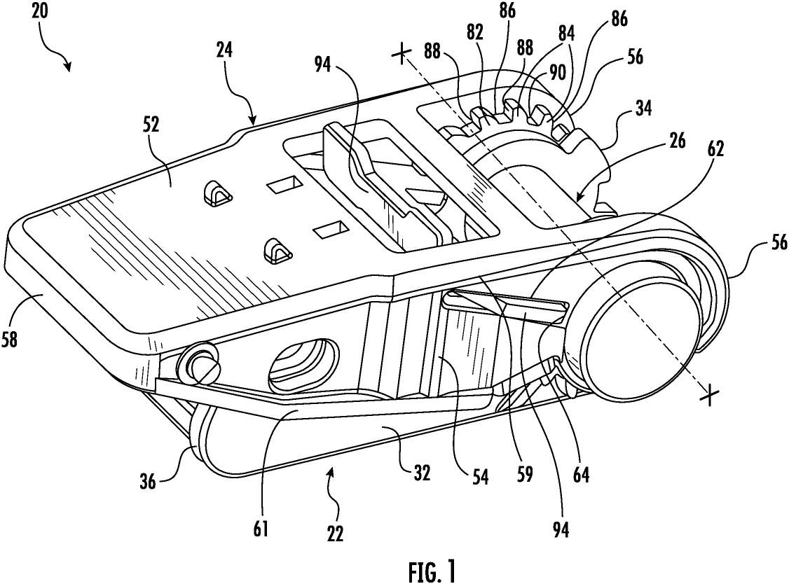

FIG. 2 is a perspective view of a body of a ratchet mechanism according to an embodiment;

FIG. 3 is a rear perspective view of a handle of a ratchet mechanism according to an embodiment;

FIG. 4 is a front perspective view of the handle of FIG. 3 according to an embodiment;

FIG. 5 is a perspective side view of a ratchet mechanism according to an embodiment;

FIG. 6 is side view of a ratchet mechanism in a closed configuration according to another embodiment; and

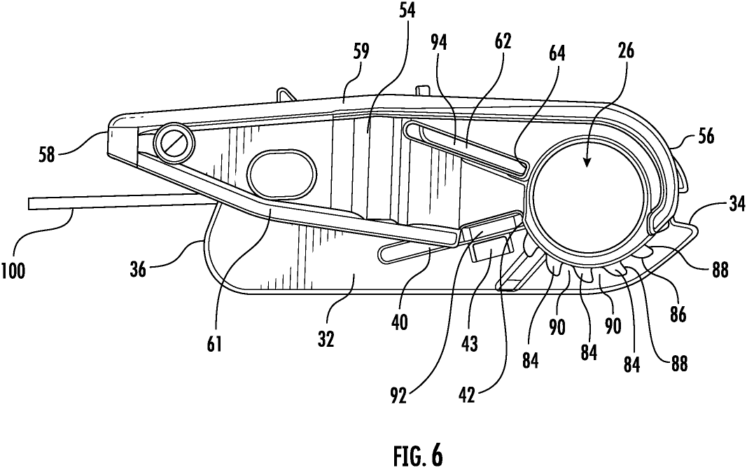

FIG. 7 is a cross-sectional view of a ratchet mechanism according to an embodiment.

### DETAILED DESCRIPTION

A detailed description of one or more embodiments of the disclosed apparatus and method are presented herein by way of exemplification and not limitation with reference to the Figures.

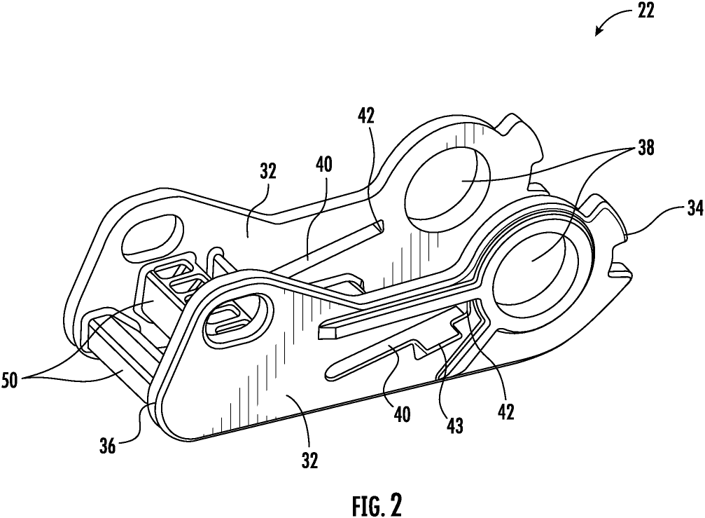

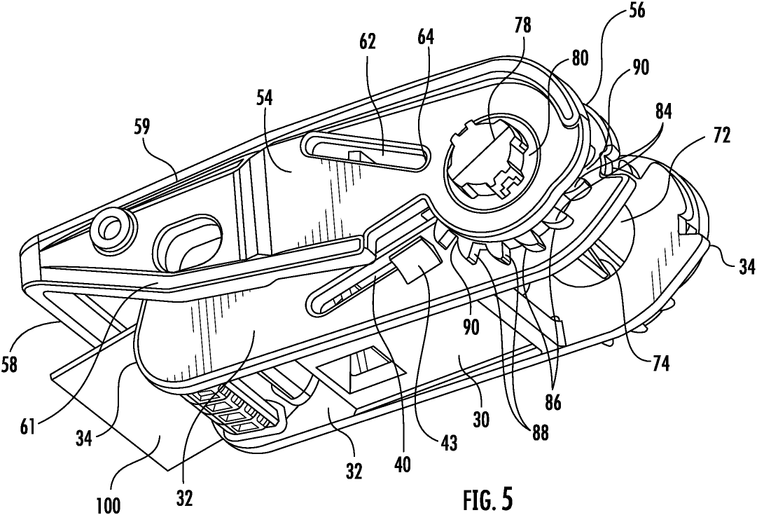

An example of a ratchet mechanism 20 suitable for tightening or tensioning a strap connected thereto is illustrated in the FIGS. As shown, the ratchet mechanism 20 includes a body 22, a handle 24, and a barrel 26. With reference now to FIG. 2, the body 22 of the ratchet mechanism 20 is illustrated in more detail. In an embodiment, the body 22 is formed from a composite or plastic material. However, embodiments where the body 22 is formed from another suitable material, such as a metal or alloy for example, are also within the scope of the disclosure. As best shown in FIGS. 2 and 5, the body 22 has a generally rectangular base 30 and two sidewalls or wings 32 are formed at opposite longitudinal sides of the base 30. A length of the sidewalls 32 may be greater than the length of the base 30. Accordingly, the base 30 may be located generally centrally relative to the sidewalls 32 such that both a first end 34 and a second, opposite end 36 of the sidewalls 32 are spaced from the base 30. The sidewalls 32 may be integrally formed with the base 30 as a single piece of material, or alternatively, may be separate components that are permanently affixed to the base 30, such as via a weld for example. The sidewalls 32 may be oriented generally parallel to one another and extend perpendicularly from the base 30 in a first direction. In an embodiment, the first end 34 of each sidewall 32 is enlarged relative to the second end 36 of the sidewall 32. However, embodiments where the ends 34, 36 of the sidewalls 32 have a similar height, as shown in the FIGS., and/or embodiments where the height of the sidewalls 32 is generally uniform over the length of the sidewalls 32 are also within the scope of the disclosure.

A pivot hole 38 is formed near the first end 34 of each sidewall 32. For example, in the illustrated, non-limiting embodiment, the enlarged first end 34 of the sidewall 32 has a generally circular configuration and the pivot hole 38 is formed at the center of the enlarged portion for example. However, the pivot hole 38 may be formed at any suitable location relative to the sidewall 32. Further, a radial slot 40 may be formed in the sidewalls 32. As shown, a first end 42 of the radial slot 40 may be located near the pivot hole 38, such as along an extended radius of the pivot hole 38. The radial slot 40 may be configured to slope downwardly as it extends toward the second end 36, away from the pivot hole 38.

In the illustrated, non-limiting embodiment, a protrusion 43 extends outwardly from a portion of each sidewall 32, directly adjacent to the radial slot 40. As shown, the protrusion 40 may be generally wedge shaped and is arranged near, but slightly offset from, the first end 42 of the radial slot 40. As shown, an upper surface of the protrusion 40 may be generally flush with the adjacent surface of the radial slot 40. Inclusion of these protrusions is intended to prevent deformation of the sidewalls 32 in response to a force acting on the radial slot 40.

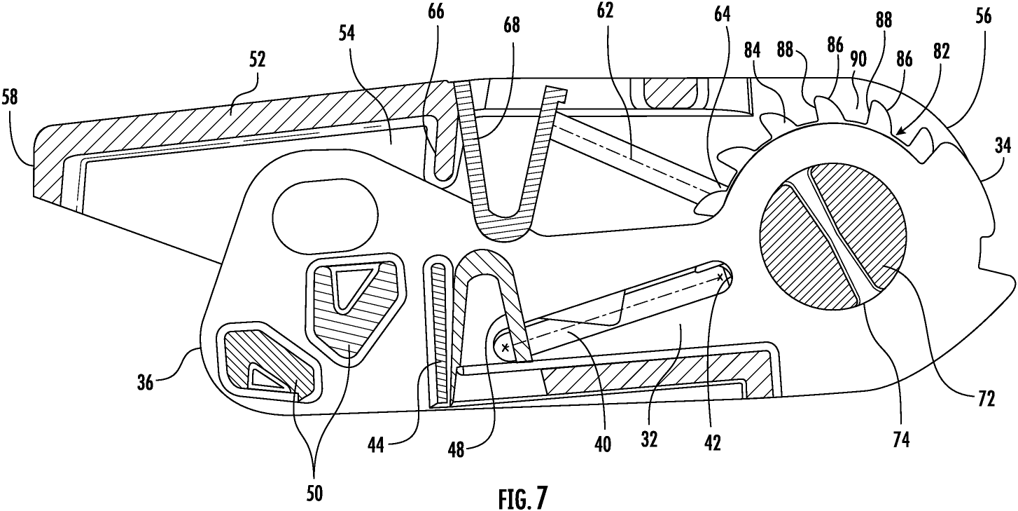

With reference to FIG. 7, a stop 44 extends vertically from the base 30 of the body 22. In an embodiment, the stop 44 is integrally formed with the sidewalls 32. As shown, the stop 44 is located at an end 46 of the base 30, closest to the second end 36 of the sidewall 32. Further, the stop 44 may, but need not extend between and contact each of the sidewalls 32.

A biasing member 48 is mounted to the base 30 and/or to the sidewalls 32 at a position near the stop 44, such as between the stop and the pivot hole 38 for example. The ratchet mechanism 20 described herein is intended for use in applications experiencing operating temperatures between -30° F. and 180° F. Accordingly, to maintain the resiliency or biasing force of the biasing member 48 across the range of operating temperatures, in an embodiment, the biasing member 48 is formed from a metal material. In the illustrated, non-limiting embodiment, the biasing member 48 has a V-shape, an inverse V-shape, a U-shape, or an inverse U-shape. However, it should be understood that a biasing member 48 having any suitable configuration is contemplated herein.

A plurality of strap holders 50 extend between the sidewalls 32 at a position between the stop 44 and the second end 36 of the sidewalls 32. Although two strap holders 50 are illustrated in the FIGS., it should be understood that any number of strap holders 50 are within the scope of the disclosure. Further, the strap holders 50 may be vertically aligned or may be vertically offset from one another, as shown in FIG. 8. The strap holders 50 may have identical configurations, or different configurations. Further the strap holders 50 may have a generally smooth uniform profile, or alternatively, may have an angular configuration as shown.

In the illustrated, non-limiting embodiment, the distance between the sidewalls 32 and the corresponding width of the strap holders 50 are designed for use with a strap or piece of webbing that is approximately 1 inch in width, such as is commonly used in marine applications. However, it should be understood that embodiments where the ratchet mechanism 20 is intended for use with webbing having any width, such as between 0.5 inches and 2.5 inches for example.

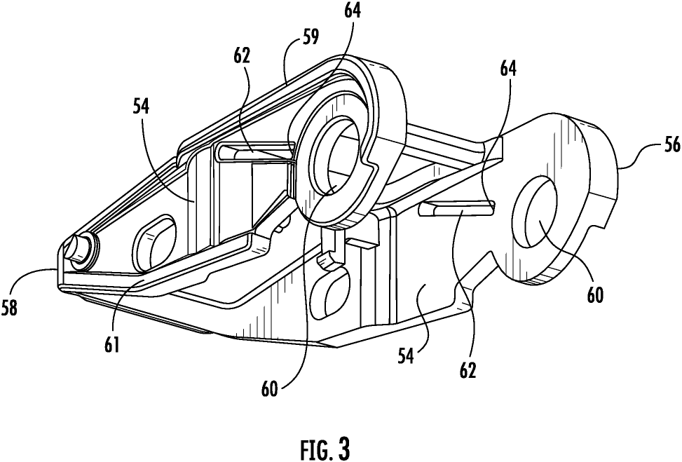

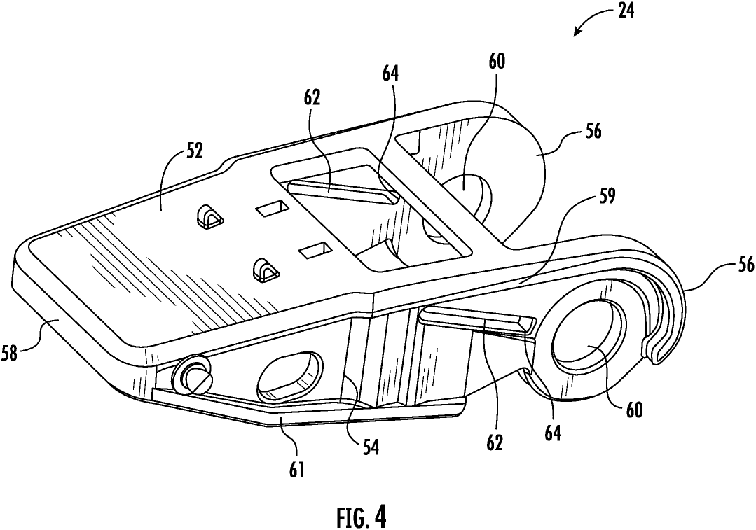

With reference now to FIGS. 3 and 4, an example of a handle 24 of the ratchet mechanism 20 is illustrated in more detail in FIGS. 3 and 4. The handle 24 similarly has a handle base 52 and two sidewalls 54 mounted at opposing longitudinal sides of the handle 24. The opposite sides of the base 52 of the handle 24 correspond with the opposite sides of the base 30 of the body 22. The sidewalls 54 may but need not be integrally formed with the handle base 52, and extend perpendicularly from the base 52, in a second direction. In the illustrated, non-limiting embodiment, the longitudinal length of the sidewalls 54 of the handle 24 is longer than the longitudinal length of the sidewalls 32 of the body 22. However, embodiments where the sidewalls 54 of the handle 24 are equal in length or shorter in length than the sidewalls 32 of the body 22 are also contemplated herein.

In an embodiment, the handle 24 is formed from a composite or plastic material. However, embodiments where the handle 24 is formed from another suitable material, such as a metal or alloy for example, are also within the scope of the disclosure. In embodiments where both the body 22 and the handle 24 are formed from a composite or plastic material, the same material may, but need not be used for both. In an embodiment, the material of the body 22 and/or handle 24 is nylon, such as a glass filled nylon. The material may be 15-30% glass filled nylon to provide stretch and break resistance against a static load of up to between about 200 pounds to about 400 pounds, such as about 300 pounds for example, that may be applied to the ratchet mechanism 20.

Each sidewall 54 of the handle 24 has an enlarged first end 56 and a second end 58. In an embodiment, the portion of the sidewalls 54 adjacent to the second end 58 is connected to the handle base 52 and the first enlarged end 56 is spaced from the handle base 52. As shown, the sidewalls 54 have a non-linear configuration. The first end 56 of each of the sidewalls 54 may be arranged at a slight angle relative to the second end 58. However, embodiments where the sidewalls 54 have another configuration, such as a linear configuration, or a more significant angular configuration are also within the scope of the disclosure. Although the enlarged first end 56 of the sidewalls 54 of the handle 24 have a similar shape to the enlarged first end 34 of the sidewalls 32 of the body 22, embodiments where the shapes are different are also within the scope of the disclosure.

In an embodiment, a rib or other protrusion 59 may extend generally outwardly from a portion of the sidewalls 54, such an adjacent to an upper edge thereof. Although the protrusion 59 is illustrated as extending from the first end 56 to the second end 58, embodiments where the protrusion 59 extends over only a portion of the length of the handle 54 are also contemplated herein. Alternatively, or in addition, a rib or protrusion 61 may extend generally outwardly from adjacent a lower edge of at least a portion of the sidewall 54.

A pivot hole 60 is similarly formed near the first enlarged end 56 of each sidewall 54 of the handle 24. However, the pivot hole 60 may be formed at any suitable location relative to the sidewall 54. Further, a radial slot 62 may be formed in the sidewalls 54, similar to the radial slot 40 of the sidewalls 32 of the body 22. As shown, a first end 64 of the radial slot 62 is located near the pivot hole 60, such as along an extended radius of the pivot hole 60, and the radial slot 62 is configured to slope upwardly as it extends toward the second end 58 of the sidewalls 54, away from the pivot hole 60.

Another stop 66 extends generally vertically from the base 52 of the handle 24, such as at an end 68 of the base 52 near the radial slot 62. Further, the stop 66 may, but need not extend between and contact each of the sidewalls 54 of the handle 24. A biasing member 70 is mounted to the base 52 and to the sidewalls 54 at a position near the stop 66. The biasing member 70, such as a stainless steel spring material for example, may be substantially identical to the biasing member 48 of the body 22. However, it should be understood that embodiments where the biasing member 70 of the handle 24 has a different configuration, including size and shape, than the biasing member 48 of the body 22 are also contemplated herein.

A barrel 26 is receivable within the pivot holes 38, 60 of the sidewalls 32, 54 of the body 22 and handle 24. In an embodiment, the barrel 26 is formed from a composite or plastic material. The material may be the same material, or alternatively, may be a different material than the body 22 and the handle 24. In an embodiment, the barrel 26 is formed from a metal material. By forming the adjacent handle 24 and body 22 from a plastic material, friction galling that typically occurs between the barrel and the sidewalls of existing metal ratchets is eliminated.

In an embodiment, the barrel 26 includes a shaft 72 having a central slot 74 (see FIG. 7) formed therein to define two generally semicircular portions. The width of the slot 74 may be very close or substantially identical to a width of the webbing member used with the ratchet 20 and received within the slot 74 to prevent breaking or distortion of the barrel 26 during operation. In an embodiment, a clip, retaining ring, or other suitable component (not shown) may be located adjacent at least one end 78 of the barrel 26 to restrict axial movement of the barrel 26 relative to the pivot holes 38, 60. However, in other embodiments, one of the ends 78 of the barrel 26 includes a flange 80 (see FIG. 5) having a diameter greater than the diameter of the pivot hole 60 and/or pivot hole 38. In such embodiments, a clip or retaining ring may be mounted at or near the end of the barrel 26 opposite the flange 80.

In an embodiment, a pair of ratchet gear wheels 82 is mounted to the shaft 72 of the barrel 26, spaced apart from one another. As shown, the ratchet gear wheels 82 may be located adjacent opposite ends 78 of the barrel 26. The ratchet gear wheels 82 are fixedly mounted to the shaft 72, and therefore are configured to rotate with the barrel 26 about a barrel axis X. In an embodiment, the ratchet gear wheels 82 are formed from a metal material.

A geometry of an opening (not shown) formed in each of the ratchet gear wheels 82 is complementary to the semicircular portions of the shaft 72. In such embodiments, the engagement between the ratchet gear wheel 82 and the semicircular portions of the shaft 72 restricts rotation of the ratchet gear wheels 82 relative to the shaft 72. However, any suitable mechanism for rotationally coupling the ratchet gear wheel 82 to the barrel 26 is within the scope of the disclosure.

Each ratchet gear wheel 82 is substantially identical and has a plurality of teeth 84 spaced about the periphery of the ratchet gear wheel 82. Each of the plurality of teeth 84 has an asymmetric configuration including a leading tooth surface 86 and a trailing tooth surface 88. In the illustrated, non-limiting embodiment, the trailing tooth surface 88 has a planar configuration and extends within a radial plane. The leading edge surface 86 is a substantially curved surface that extends to the distal end of the trailing edge surface 88. As shown, the trailing edge surface 88 of a first tooth 84 may be circumferentially offset from the leading edge surface 86 of an adjacent tooth 84, thereby creating a clearance or gap 90 between adjacent teeth 84. Although the circumferential length of the clearance 90 is illustrated as being smaller than the circumferential length of the teeth 84, embodiments where the circumferential lengths are equal, or alternatively, where the circumferential length of the clearance 90 is greater than that of the teeth 84 are also contemplated herein. By forming this clearance 90 between adjacent teeth 84, misalignment between the driver or pawl 94, 92 and a corresponding tooth 84 of the ratchet gear wheel 82, such as if a tooth of one of the ratchet gear wheels 82 misses the driver of pawl 94, 92, will not distort or break the ratchet mechanism 20.

The handle 24 is pivotally connected to the body 22 via the barrel 26. In an embodiment, a width of the handle 24 is greater than a width of the body 22. As a result, each of the sidewalls 54 of the handle 24 is arranged adjacent to and offset from an exterior surface of a sidewall 32 of the body 22. The ratchet gear wheels 82 are arranged within the resulting clearance between the pairs of sidewalls 32, 54, respectively. When installed, a portion of the ratchet gear wheels 82 overlaps with an adjacent end 42, 64 of the radial slots 40, 62 of both the body 22 and handle 24.

A pawl 92 is arranged within the body 22 of the ratchet mechanism 20. In an embodiment, the pawl 92 is formed from a metal material, such as stainless steel for example. As shown, the sides of the pawl 92 extend through the radial slots 40 formed in the sidewalls 32 of the body 22. Accordingly, the pawl 92 is configured to translate relative to the body 22 along the path defined by the radial slots 40. The pawl 92 may additionally include a protrusion or stub (not shown) extending towards and configured to engage the biasing member 48. A driver 94 having a similar configuration to the pawl 92 may be mounted within the handle 24. The sides of the driver 94 are received within the radial slots 62 formed in the sidewalls 54 of the handle 24 and a portion of the driver 94 extends towards the biasing member 70.

The ratchet gear wheels 82 are mounted such that as the handle 24 is rotated about the axis X of the barrel 26, between a closed and an open configuration, the driver 94 engages the teeth 84 of the ratchet gear wheels 82 causing the ratchet gear wheels 82 to rotate about the axis X. Accordingly, as the handle 24 rotates away from the body 22, toward an open configuration, the ratchet gear wheels 82 and the barrel 26 rotate in the same direction as the handle 24 about axis X. At the same time, the sides of the pawl 92 engage a tooth 84 of each respective ratchet gear wheel 82 to restrict rotation about the axis X in a second, opposite direction. More specifically, when the handle 24 is rotated towards the body 22, the biasing member 70 of the handle 24 is compressed by the driver 94, and the biasing member 48 of the body 22 is compressed by the pawl 92. Upon release of the handle 24 (such as when the handle reaches the closed configuration), the biasing members 48, 70 will cause the driver 94 and the pawl 92 to slide within their respective radial slots 40, 62 causing both the driver 94 and the pawl 92 to engage a tooth 84 of each respective ratchet gear wheel 82, thereby restricting rotation of the ratchet gear wheels 82.

As described herein, during operation of the ratchet, the pawl 92, the driver 94, the biasing members 48, 70 and the ratchet gear wheels 82 are configured to have the greatest force applied thereto, and therefore may be considered the “force receiving members” of the ratchet mechanism 20. Because these members are configured to withstand the greatest loads, in an embodiment, one or more of these force receiving members are formed from a first, metal material, while the other components of the ratchet mechanism are formed from a second material, different than the first material. In an embodiment, the second material is a plastic material.

A first portion of a strap 100, such as a 1 inch piece of webbing for example, illustrated schematically at 100 (see FIGS. 2, 5, and 7), is attached to the one or more strap holders 50 of the body 22, and a second portion or end of the strap 100 is receivable within the ratchet mechanism 20 underneath the barrel 26. When the ratchet mechanism 20 is operated to tighten the strap 100, the first portion of the strap 100 is held in place relative to the strap holders 50 via friction. Accordingly, a hook or permanent strap loop is not required for operation of the mechanism.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A ratchet mechanism comprising:
a barrel defining an axis of rotation;
a body and a handle coupled via the barrel, the handle being rotatable relative to the body about the axis of rotation; and
at least one force receiving member operably coupled to at least one of the barrel, the body, and the handle, wherein the at least one force receiving member is formed from a first material, and at least one of the barrel, the body, and the handle is formed from a second material, different than the first material.

2. The ratchet mechanism of claim 1, wherein the at least one force receiving material is formed from a metal material.

3. The ratchet mechanism of claim 1, wherein each of the barrel, the body, and the handle is formed from the second material.

4. The ratchet mechanism of claim 3, wherein the second material is a plastic material.

5. The ratchet mechanism of claim 1, wherein the at least one force receiving member includes a pawl.

6. The ratchet mechanism of claim 1, wherein the at least one force receiving member includes a driver.

7. The ratchet mechanism of claim 1, wherein the at least one force receiving member includes a biasing mechanism.

8. The ratchet mechanism of claim 1, wherein the at least one force receiving member includes a ratchet gear wheel.

9. The ratchet mechanism of claim 8, wherein the at least one ratchet gear wheel is mounted to the barrel at a position between a portion of the body and the handle.

10. The ratchet mechanism of claim 1, wherein the ratchet mechanism is usable in a marine application.

11. The ratchet mechanism of claim 1, wherein a strap is receivable within the body, the strap having a width of about one inch.

12. The ratchet mechanism of claim 1, wherein the ratchet mechanism is configured to provide stretch and break resistance against a static load of up to 400 pounds.

13. The ratchet mechanism of claim 12, wherein the ratchet mechanism is configured to provide stretch and break resistance against a static load of up to 300 pounds.
